(19) United States
(12) Patent Application Publication
(10) Pub. No.: US 2009/0282977 A1
(43) Pub. Date: Nov. 19, 2009

(54) GAS PURIFICATION SYSTEM HAVING PROVISIONS FOR CO2 INJECTION OF WASH WATER

(75) Inventor: Peter Ulrich Koss, Zollikon (CH)

Correspondence Address: ALSTOM POWER INC.;INTELLECTUAL PROPERTY LAW DEPT., P.O. BOX 500, WINDSOR, CT, 06095, US

(73) Assignee: ALSTOM TECHNOLOGY LTD, Baden (CH)

(21) Appl. No.: 12/436,309

(22) Filed: May 6, 2009

Related U.S. Application Data
(60) Provisional application No. 61/053,156, filed on May 14, 2008.

(51) Int. Cl. B01D 47/00; B01D 47/14

(52) U.S. Cl. 95/199; 96/243

(57) ABSTRACT

The present invention relates to a methods and systems for the removal of contaminants from a gas stream, comprising the steps of: a)introducing CO₂ into a wash water stream to obtain a CO₂ enriched wash water; and b) contacting said CO₂ enriched wash water with the gas stream containing contaminants to be removed to allow absorption of the contaminants into the CO₂ enriched wash water. The present invention further relates to the use of CO₂ enriched wash water for removal of alkaline contaminants from a gas stream in a gas purification system.

### CROSS-REFERENCE TO RELATED APPLICATION

This application claims the benefit of U.S. Provisional Patent Application Ser. No. 61/053,156 filed May 14, 2008, which is hereby incorporated by reference in its entirety.

### FIELD OF THE INVENTION

The present invention relates to methods and systems for removal of contaminants from gas streams.

### BACKGROUND

In processes used for industrial separation of acidic components such as H₂S, CO₂, COS and/or mercaptans from a gas stream such as flue gas, natural gas, syngas or other gas streams mainly containing nitrogen, oxygen, hydrogen, carbon monoxide and/or methane, liquid solutions comprising amine compounds or aqueous ammonia solutions are commonly used as a solvent. The acidic components are absorbed in the solvent in an absorption process. This process may be generally referred to as the main scrubbing process.

After “scrubbing” of said acidic components by said solutions, contaminants, such as traces of ammonia, amine compounds or degradation products of amine compounds, remain in the gas stream. These contaminants have to be removed from the gas stream in a separate process step.

Currently known systems and methods provide for the removal of these contaminants from a gas stream in a water wash step. In the water wash step, the gas stream is scrubbed with water in an suitable contacting device. Typically, the water used to scrub the gas stream is either fresh water or water obtained from a stripping process related to the treatment of the gas stream.

After the gas stream is scrubbed with water, the water is 1) sent back to the stripping unit from which it was obtained or 2) simply mixed with the solution used in the main scrubbing process.

Regeneration of used wash liquids, for example in a stripping unit, is generally an energy intensive, and thus expensive, process. Thus, there is a need for processes that improve wash efficiency and/or reduce wash liquid consumption.

### SUMMARY

It is an object of the present invention to improve the wash efficiency of a water wash step in a gas purification process.

Another object of the invention is to reduce the wash water consumption of a water wash step in a gas purification process.

Another object, related to the above mentioned objects is to reduce the costs of a gas purification process by improving the wash efficiency and/or reducing the wash water consumption of a water wash step in the gas purification process.

Other objects of the present invention may be to obtain environmental, health and/or economical benefits of reduced emission of chemicals used in a gas purification process.

In a first aspect of the present invention, the above mentioned objects, as well as further objects, which will become apparent to the skilled person when presented with the present disclosure, are achieved by a method for the removal of contaminants from a gas stream, comprising the steps of:
a) introducing CO₂ into a wash water stream to obtain a CO₂ enriched wash water; and
b) contacting said CO₂ enriched wash water with the gas stream containing contaminants to be removed to allow absorption of the contaminants into the CO₂ enriched wash water.

The term “contaminant”, as used herein, refers generally to an undesired component present in a gas stream. The contaminant will generally be present in a minor amount by volume in the gas stream. The contaminant may be undesired e.g. because it lowers the usefulness of the gas stream in a subsequent application or further treatment process or because it imparts undesirable properties to the gas stream, such as toxicity, environmental disadvantages, odors, etc. Examples of contaminants include ammonia, amine compounds, and decomposition products from amine compounds.

The term “wash water”, as used herein, refers generally to an aqueous medium used for removal of contaminants from a gas stream by bringing said gas stream into contact with said wash water, resulting in the absorption of contaminants from said gas stream into said wash water. The wash water containing the absorbed contaminants is generally recycled, e.g. in a stripping unit, whereby the contaminants may be concentrated for incineration or purification and reuse.

The introduction of CO₂ in the wash water prior to use in a water wash unit results in a substantial and unexpected improvement of the efficiency of the water wash step for the removal of alkaline contaminants such as e.g. ammonia and amine compounds. Although the present invention is not bound by any particular scientific explanation, a contributing factor in this substantial improvement may be a shift of the pH value in the wash water to the acidic side caused by the dissolution of CO2 in the wash water as carbonic acid. Generally, the contaminants introduced in the gas stream through the solvent being used in the main scrubbing process have a caustic or slightly caustic character. As such, the vapor/liquid equilibrium of the respective contaminant can be improved if the pH value of the water is shifted to the acidic side. However, the substantial improvement goes far beyond what could be attributed solely to such shift of the pH value.

As a consequence the amount of wash water needed to conduct scrubbing operations can be lowered considerably. This reduction in wash water consumption can be used, for example, to improve the economics of the water wash process, if the used wash water is sent to a stripping unit, as the amount of energy needed in the stripping is almost proportional to the amount of water to be stripped. As an example, tests on a commercial plant with a flow scheme as shown in FIG. 3 have shown a 20% decrease in the amount of steam fed to the stripper reboiler when compared to tests on the same commercial plant using the flow scheme of FIG. 1. Furthermore, tests on a commercial plant with a flow scheme as shown in FIG. 4 have shown an improved absorption efficiency of the wash water such that the amount of wash water required to reduce the residual amine and ammonia content to an acceptable level was decreased by 19% when compared to tests on the same commercial plant using the flow scheme of FIG. 2 at the same residual amine and ammonia content levels.

In other words, the economics of the water wash step are dictated by the amount of wash water needed to reach the required removal rate of trace contaminants. The amount of wash water needed to properly scrub the gas stream is dictated by the absorption capacity of the water for the respective trace contaminants, i.e. the vapor/liquid equilibrium between the contaminant in the gas phase and in the water phase.

Alternatively, the improved absorption capacity of the wash water may be used to further reduce the amount of contaminants present in the gas stream leaving the water wash step, without increasing the wash water consumption. In other words emissions can be reduced without a corresponding increase in costs due to increased water and energy consumption.

The use of CO₂ for improving the absorption capacity of wash water is further advantageous because, e.g., i) CO₂ is odorless and relatively non-toxic, ii) any CO₂ remaining in the wash water after use may easily be removed during the regeneration of the wash water, and iii) CO₂ may, in at least some embodiments of the present invention, be readily available as a product from another process step.

The method of the invention has been shown to be especially useful for the removal of alkaline contaminants, i.e. contaminants that have a pKₐ value above 7. Thus, preferably at least one of the contaminants to be removed from the gas stream is an alkaline compound.

Alkaline compounds are often used in absorption processes for removal of acidic gases, such as CO₂, H₂S and COS from gas streams. The gas purification method of the present invention is efficient for the removal of alkaline contaminants from gas streams. Examples of alkaline compounds include, but are not limited to, ammonia and amine compounds such as monoethanolamine (MEA), diethanolamine (DEA), methyldiethanolamine (MDEA), diisopropylamine (DIPA) and aminoethoxyethanol (diglycolamine) (DGA). The most commonly used amines compounds in industrial plants are the alkanolamines MEA, DEA, and MDEA. Preferably at least one of the contaminants to be removed is selected from the group consisting of ammonia and amine compounds. Preferably, one of the contaminants to be removed is ammonia.

The amount of CO₂ introduced into the wash water should be sufficient to result in an improved contaminant absorption efficiency as compared to wash water in which no CO₂ has been introduced. Generally, only a small amount of CO₂ needs to be introduced into the wash water in order to obtain an improvement in the absorption efficiency in the water wash step. The CO₂ may for example be introduced in an amount such that the resulting CO₂ enriched wash water comprises more than 0.01 wt % of CO₂. The upper limit of the amount of CO₂ in the CO₂ enriched wash water is generally dictated by practical considerations. Also, if the gas purification method is a part of a larger process for removal of CO₂ from a gas stream, e.g. from a flue gas stream, the amount of CO₂ introduced may preferably be selected such that the introduction of CO₂ into the wash water does not have a substantial negative effect of the overall CO₂ removal efficiency of said process. The amount of CO₂ introduced may preferably be such that the resulting CO₂ enriched wash water comprises less than 5 wt % of CO₂, and more preferably less than 2 or 1 wt % of CO₂.

The amount of CO₂ introduced into the wash water may preferably be such that the CO₂ enriched wash water comprises 0.01-5 wt % of CO₂. For example amount of CO₂ introduced may be such that the CO₂ enriched wash water comprises 0.01-2 wt % of CO₂ or such that the CO₂ enriched wash water comprises 0.01-1 wt % of CO₂.

The CO₂ introduced into the wash water may be in various physical forms. The CO₂ may for example be introduced in solid, liquid, supercritical fluid, or gas form, or a mixture thereof. It has been found that the CO₂ may conveniently be introduced into the wash water stream in liquid form. Thus, the CO₂ introduced into the wash water stream in step a) may preferably be in liquid form.

In processes for separation of CO₂ from a gas stream, for example flue gas or natural gas, CO₂ may be recycled from, for example, a CO₂ compressor present in the purification system. Alternatively, CO₂ may be obtained from other sources and used for injecting into the wash water stream. Preferably, the CO₂ introduced is CO₂ obtained from a process for removal of CO₂ from a gas stream, e.g. from a process for removal of CO₂ from a gas stream comprising the step of scrubbing said gas stream with a liquid comprising ammonia or an amine compound, preferably ammonia.

In an especially advantageous embodiment, the gas stream to be purified has been subjected to CO₂ depletion in a previous process step, and the CO₂ removed in said previous process step is available for introduction into the wash water stream of the subsequent water wash step. Thus in a method according to the invention, in step b), the gas stream containing contaminants to be removed of may be a product resulting from a process for removal of CO₂, and the CO₂ introduced into the wash water stream in step a) be obtained from said process for removal of CO₂.

In the inventive method, the contacting of CO₂ enriched wash water with the gas stream containing contaminants to be removed to allow absorption of the contaminants into the CO₂ enriched wash water may be brought about in various arrangements, which will be readily recognizable to a person skilled in the art. It has been found that especially efficient absorption is achieved when said contacting is performed in countercurrent flow mode. The contacting may be performed in any suitable absorption device. The contacting may for example be performed in a packed bed column.

Generally, CO₂ may be obtained from any available source and used for injecting into the wash water stream. However, in processes for the separation of CO₂ from a gas stream, for example flue gas or natural gas, CO₂ may be recycled from, for example, a CO₂ compressor present in the purification system.

Features mentioned above, in respect of the first aspect of the invention, may also be applicable to some or all embodiments of all aspects of the invention described hereinbelow.

The present invention may be especially useful in gas purification applications wherein at least one contaminant to be removed has a caustic or slightly caustic character. For example, the gas purification method of the present invention is suitable for use in a an ammonia or amine based gas purification process for removal of CO₂ from a gas stream, such as a flue gas stream. Such a process generally comprises an absorption step, wherein the gas stream is contacted with a wash liquid comprising ammonia or an amine compound in an absorption unit, and CO₂ in the gas stream is absorbed in said wash liquid. The CO₂ depleted gas stream which leaves the absorption unit will contain traces of the ammonia or amine compound used in the wash liquid. The gas purification method of the present invention provides for efficient removal of such traces of ammonia or amine compounds from the gas stream.

Thus, in a second aspect thereof, the present invention provides a method for the removal of contaminants from a gas stream, comprising the steps of: a) removing CO₂ from a CO₂ rich gas stream to obtain a CO₂ lean gas stream; b) introducing CO₂ removed from said CO₂ rich gas stream in step a) into a wash water stream to obtain a CO₂ enriched wash water; and c) contacting said CO₂ enriched wash water with the CO₂ lean gas stream obtained in step a) to allow absorption of contaminants in the CO₂ lean gas stream into the CO₂ enriched wash water.

Steps b) and c) of the method according to the second aspect of the invention may in some embodiments correspond to steps a) and b) of the method according to the first aspect of the invention respectively. Thus, the method of the second aspect of the invention may in some embodiments be further defined as described above in respect of the first aspect of the invention.

The present invention also provides a gas purification system provided with means for introducing CO₂ into a wash water stream and adapted to perform the inventive method.

Thus, in a third aspect thereof, the present invention provides a gas purification system comprising a contactor device arranged for receiving a gas stream and contacting it with a wash water stream, characterized in that said system comprises means for introducing CO₂ into said wash water stream upstream of said contactor device.

The contactor device, also referred to herein as the water wash unit, may preferably comprise an absorption unit, e.g. a packed bed column adapted for contacting a gas stream with a wash water stream. The contactor device may preferably be arranged for operation in countercurrent flow mode.

The means for introducing CO₂ into the said wash water may be adapted for introducing CO₂ in solid, liquid supercritical fluid, or gaseous form into said wash water. Preferably, the means for introducing CO₂ into said wash water may be adapted for introducing CO₂ in liquid form. CO₂ in liquid form may for example be introduced into the wash solution via an injection nozzle.

The gas purification system of the present invention may be especially useful in gas purification applications wherein at least one contaminant to be removed has a caustic or slightly caustic character. For example, the gas purification system of the present invention is suitable for use in a an ammonia or amine based gas purification process for removal of CO₂ from a gas stream, such as a flue gas stream. Such a process generally comprises an absorption step, wherein the gas stream is contacted with a wash liquid comprising ammonia or an amine compound in an absorption unit, and CO₂ in the gas stream is absorbed in said wash liquid. The CO₂ depleted gas stream which leaves the absorption unit will contain traces of the ammonia or amine compound used in the wash liquid. The gas purification system of the present invention provides for efficient removal of such traces of ammonia or amine compounds from the gas stream.

Thus, the gas purification system of the present invention may further comprise a second contactor device arranged for receiving a CO₂ rich gas stream and contacting it with a liquid comprising ammonia or an amine compound to produce a CO₂ lean gas stream, wherein said first contactor device is arranged for receiving said CO₂ lean gas stream and contacting it with a wash water stream, and wherein said system comprises means for introducing CO₂ into said wash water stream upstream of said first contactor device.

In the gas purification system, said means for introducing CO₂ into said wash water stream may be adapted for introducing CO₂ removed from the CO₂ rich gas stream in the second contactor device into the wash water stream upstream of said first contactor device.

Preferably, the CO₂ introduced into the wash water stream in a gas purification system according to the fourth aspect of the invention may be CO₂ obtained from the CO₂ rich gas stream in the first contactor device. Thus, the means for introducing CO₂ into said wash water stream may preferably be adapted for introducing CO₂ removed from the CO₂ rich gas stream in the first contactor device into the wash water stream upstream of said second contactor device.

In a fourth aspect thereof, the present invention provides the use of CO₂ enriched wash water for removal of alkaline contaminants from a gas stream in a gas purification system.

The concentration of CO₂ in the CO₂ enriched wash water may preferably be higher than 0.01 wt %. The upper limit of the amount of CO₂ in the CO₂ enriched wash water is generally dictated by practical considerations. Also, if the CO₂ enriched wash water is used in a wash step in a process for removal of CO₂ from a gas stream, e.g. from a flue gas stream, the CO₂ concentration may preferably be selected such that the use of the CO₂ enriched wash water does not have a substantial negative effect of the overall CO₂ removal efficiency of said process. The concentration of CO₂ may preferably be less than 5 wt % of CO₂, and more preferably less than 2 or 1 wt % of CO₂.

The CO₂ enriched wash water preferably comprises 0.01-5 wt % of CO₂. The CO₂ enriched wash water may for example comprise 0.01-2 wt % of CO₂ or 0.01-1 wt % of CO₂.

The CO₂ enriched wash water may for example be obtained by introduction of CO₂ in liquid form into wash water.

The use of CO₂ enriched wash water for removal of alkaline contaminants from a gas stream in a gas purification system may be especially useful in a gas purification system for removal of CO₂ from a gas stream by contacting said gas stream with a liquid comprising ammonia or an amine compound.

### BRIEF DESCRIPTION OF THE DRAWINGS

FIG. 1 (Prior art) is a diagram generally depicting a known ammonia based gas purification system.

FIG. 2 (Prior art) is a diagram generally depicting a known amine based gas purification system.

FIG. 3 is a diagram generally depicting an embodiment of an ammonia based gas purification system according to the proposed invention.

FIG. 4 is a diagram generally depicting an embodiment of an amine based gas purification system according to the proposed invention.

### DETAILED DESCRIPTION

Specific embodiments of gas purification systems of the prior art and of the present invention are described in detail hereinbelow with reference to the drawings.

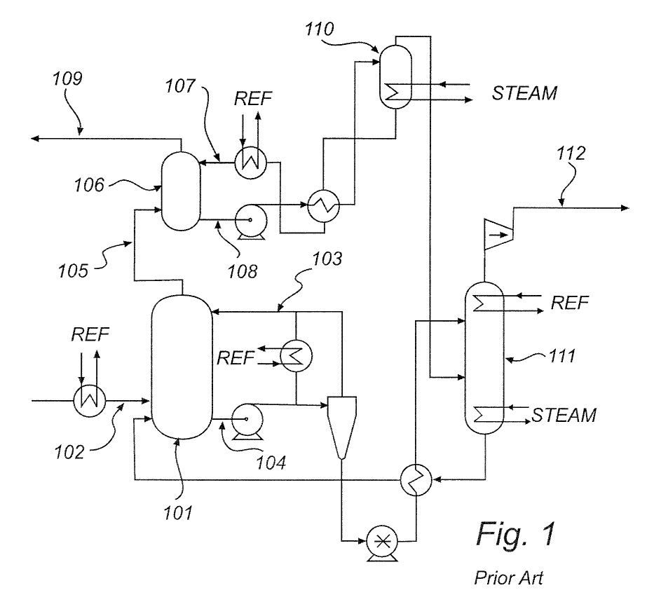

FIG. 1 is a schematic representation of a conventional chilled ammonia based gas purification system. The system comprises a CO₂ absorption unit (101) arranged to allow contact between a gas stream to be purified and a wash liquid comprising ammonia. Flue gas from which CO₂ is to be removed, is fed to the CO₂ absorption unit (101) via line (102). In the CO₂ absorption unit the flue gas is contacted with a wash liquid comprising ammonia, e.g. by bubbling the flue gas through said wash liquid or by spraying the wash liquid into the flue gas. The wash liquid comprising ammonia is fed to the CO₂ absorption unit via line (103). In the CO₂ absorption unit (101) CO₂ from the flue gas is absorbed in the wash liquid, e.g. by formation of carbonate or bicarbonate of ammonium either in dissolved or solid form. Used wash liquid containing absorbed CO₂ leaves the absorption unit via line (104) and is brought to a stripping unit (111) where CO₂ is separated from the wash liquid. The separated CO₂ leaves the stripping unit via line (112). Flue gas depleted of CO₂ leaves the CO₂ absorption unit via line (105).

The system represented by FIG. 1 further comprises a water wash unit (106). The water wash unit is arranged to allow contact between the flue gas depleted of CO₂which leaves the CO₂ absorption unit (101) and wash water. The wash water is fed to the water wash unit via line (107). In the water wash unit, contaminants remaining in the flue gas when it leaves the CO₂ absorption unit are absorbed in the wash water. Used wash water containing absorbed contaminants leaves the water wash unit via line (108). Flue gas depleted of CO₂ and contaminants leaves the water wash unit (106) via line (109). The wash water may be recycled via a regenerator unit (110), wherein contaminants are separated from the wash water.

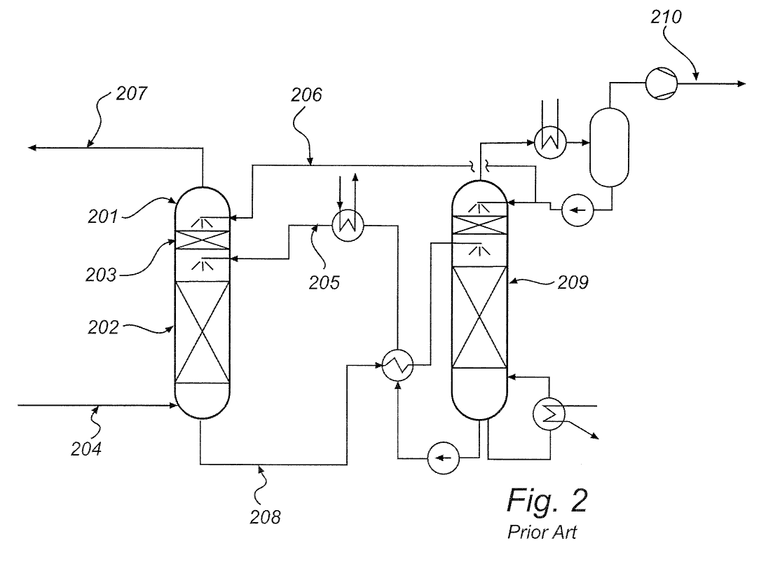

FIG. 2 is a schematic representation of a conventional amine based gas purification system. The system comprises an absorption unit (201) arranged to allow contact between a gas stream to be purified and one or more wash liquids. The absorption unit represented in FIG. 2 comprises a CO₂ absorption section (202) and a water wash section (203). Flue gas from which CO₂ is to be removed, is fed to the absorption unit (201) via line (204). In the CO₂ absorption section (202), the flue gas is contacted with a first wash liquid comprising an amine compound, e.g. by bubbling the flue gas through said first wash liquid or by spraying the first wash liquid into the flue gas. The first wash liquid is fed to the absorption unit via line (205). In the CO₂ absorption section (202) CO₂ from the flue gas is absorbed in the first wash liquid. Flue gas depleted of CO₂ in the CO₂ absorption section then enters the water wash section (203) of the absorption unit. The water wash section (203) is arranged to allow contact between the flue gas depleted of CO₂ from the CO₂ absorption section (202) and a second wash liquid, which is generally water. The second wash liquid is fed to the absorption unit via line (206). In the water wash section, contaminants remaining in the flue gas when it leaves the CO₂ absorption section are absorbed in the second wash liquid. Flue gas depleted of CO₂ and contaminants leaves the absorption unit via line (207). The used first and second wash liquid containing absorbed CO₂ and contaminants leave the absorption unit via line (208). The used first and second wash liquid may be recycled via a regenerator unit (209), wherein contaminants and CO₂ are separated from the wash water. The separated CO₂ leaves the system via line (210).

In an embodiment thereof, the present invention comprises a contactor device, also referred to herein as a water wash unit. The water wash unit may be arranged by itself as a standalone operational unit, or as an integrated portion of a main absorption unit, such as e.g. a CO₂ absorption unit. In all embodiments, the water wash unit may be arranged as a plurality of units or operational steps in parallel or in series.

A gas stream, e.g. flue gas, comprising contaminants to be removed is fed to the water wash unit. In the water wash unit the gas stream is contacted with a wash water stream, e.g. by bubbling the flue gas through said wash liquid or by spraying the wash liquid into the gas stream. In the water wash unit contaminants from the gas stream are absorbed in the wash water, either in dissolved or solid form.

In addition to the mentioned features, the gas purification system further comprises means for introducing CO₂ into the said wash water stream upstream of said water wash unit.

In all embodiments, the CO₂ may be introduced into the wash water stream anywhere upstream of the water wash unit, for example to a wash water supply or to a line connecting a wash water supply to the water wash unit, or directly to the water wash unit.

In all embodiments, the means for introducing CO₂ may be adapted for introducing CO₂ in solid, liquid, supercritical fluid, or gaseous form into said wash water. The CO₂ which is introduced into the wash water may be maintained in a desired physical form by providing it at a suitable temperature and/or under a pressure. Suitable temperatures and pressures for maintaining the CO₂ in a desired physical form may readily be determined by a person skilled in the art using a CO₂ pressure-temperature phase diagram.

Various methods may be used for introducing the CO₂ into the wash water. Examples of means for introducing CO₂ into said wash water include, but are not limited to, a mixing unit for mixing the wash water with CO₂ in solid form to allow CO₂ to dissolve in the wash water, a mixing unit for mixing the wash water with CO₂ in solid form to allow CO₂ to dissolve in the wash water, and a CO₂ absorption unit wherein gaseous CO₂ is contacted with a the wash water, e.g. by bubbling the CO₂ through said wash water or by spraying the wash water into said gaseous CO₂.

The means for introducing CO₂ into said wash water may preferably be adapted for introducing CO₂ in liquid form. CO₂ in liquid form may for example be introduced into the wash solution via an injection nozzle.

The means for introducing CO₂ into said wash water may include a mixing unit, such as for example a mixing chamber, to ensure uniform distribution of CO₂ in the wash water. Alternatively or as a complement, a separate mixing unit to ensure uniform distribution of CO₂ in the wash water may be arranged at the wash water supply or at a line connecting a wash water supply to the water wash unit.

The means for introducing CO₂ into said wash water upstream of said water wash unit may be arranged to provide CO₂ from any suitable CO₂ supply or source. In processes for the separation of CO₂ from a gas stream, for example flue gas or natural gas, CO₂ may be recycled from, for example, a CO₂ compressor present in the purification system. Alternatively, CO₂ may be obtained from other sources and used for injecting into the wash water stream.

The system may further comprise means for measuring and/or controlling the amount of CO₂ which is added to the wash water stream. Said means for measuring and/or controlling the amount of CO₂ which is added to the wash water stream may also be connected means for measuring other values in the gas purification system, such as values representing the efficiency of removal of contaminants in the water wash unit. Such an arrangement allows for the amount of CO₂ introduced into the wash stream to be adjusted to achieve optimal efficiency of removal of contaminants in the water wash unit.

The water wash unit is arranged to allow contact between a contaminated gas stream and a wash liquid, which is generally water. The water wash unit may e.g. comprise an absorption column, such as a packed bed column. The water wash unit may preferably be arranged to operate in countercurrent flow mode. As an example, the water wash unit may comprise an absorption column arranged to operate in countercurrent flow mode, wherein the contaminated gas is fed at the bottom portion of the column, and the wash water is fed at the top portion of the column, such that the gas is brought into contact with the wash water as it rises up through the column. The gas stream depleted of contaminants leaves the column at the top portion of the column, while the wash water containing contaminants absorbed from the gas stream leaves the column at the bottom portion of the column. The countercurrent flow mode may be especially advantageous in an embodiment, wherein the water wash unit forms an integrated portion or section of a main absorption unit, such as e.g. a CO₂ absorption unit and wherein the water wash portion or section is arranged on top of a CO₂ absorption portion or section.

Features mentioned above, relating to means and methods for introducing CO₂ into wash water, may also be applicable to the detailed embodiments described hereinbelow.

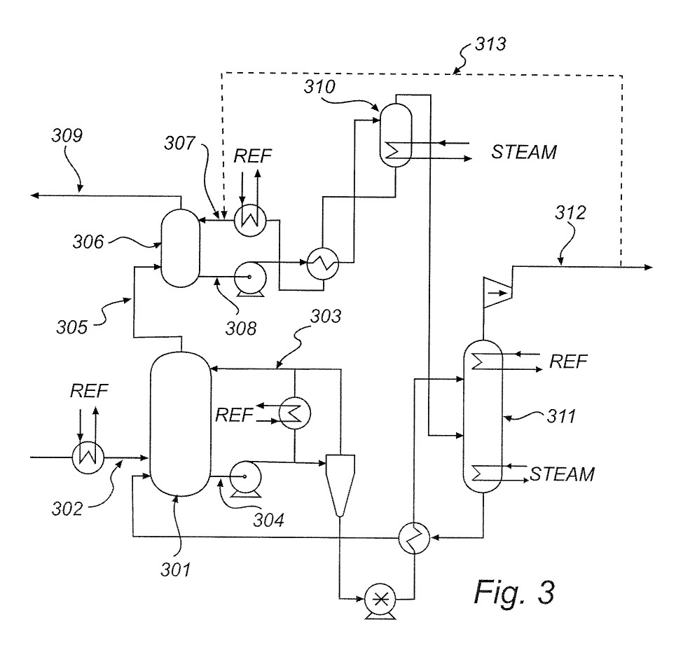

FIG. 3 is a schematic representation of an embodiment of an ammonia based gas purification system according to the proposed invention. The system comprises a CO₂ absorption unit (301) arranged to allow contact between a gas stream to be purified and a wash liquid comprising ammonia. Flue gas from which CO₂ is to be removed, is fed to the CO₂ absorption unit (301) via line (302). In the CO₂ absorption unit the flue gas is contacted with a wash liquid comprising ammonia, e.g. by bubbling the flue gas through said wash liquid or by spraying the wash liquid into the flue gas. The wash liquid comprising ammonia is fed to the CO₂ absorption unit via line (303). In the CO₂ absorption unit (301) CO₂ from the flue gas is absorbed in the wash liquid, e.g. by formation of carbonate or bicarbonate of ammonium either in dissolved or solid form. Used wash liquid containing absorbed CO₂ leaves the absorption unit via line (304) and is brought to a stripping unit (311) where CO₂ is separated from the wash liquid. The separated CO₂ leaves the stripping unit via line (312). Flue gas depleted of CO₂ leaves the CO₂ absorption unit via line (305).

The system represented by FIG. 3 further comprises a water wash unit (306). The water wash unit is arranged to allow contact between the flue gas depleted of CO₂ which leaves the CO₂ absorption unit (301) and wash water. The wash water is fed to the water wash unit via line (307). In the water wash unit, contaminants remaining in the flue gas when it leaves the CO₂ absorption unit are absorbed in the wash water. Used wash water containing absorbed contaminants leaves the water wash unit via line (308). Flue gas depleted of CO₂ and contaminants leaves the water wash unit (301) via line (309). The wash water may be recycled via a regenerator unit (310), wherein contaminants are separated from the wash water.

In addition to the mentioned features, the system represented by FIG. 3 further comprises means (313) for introducing CO₂ into said wash water stream upstream of said water wash unit.

CO₂ removed from the flue gas in the absorption unit is separated from the wash liquid in a stripping unit (311) for regeneration of the wash liquid. Separated CO₂ leaves the stripping unit via line (312). A portion of the CO₂ separated in the stripping unit is introduced into the wash water to be fed to the water wash unit.

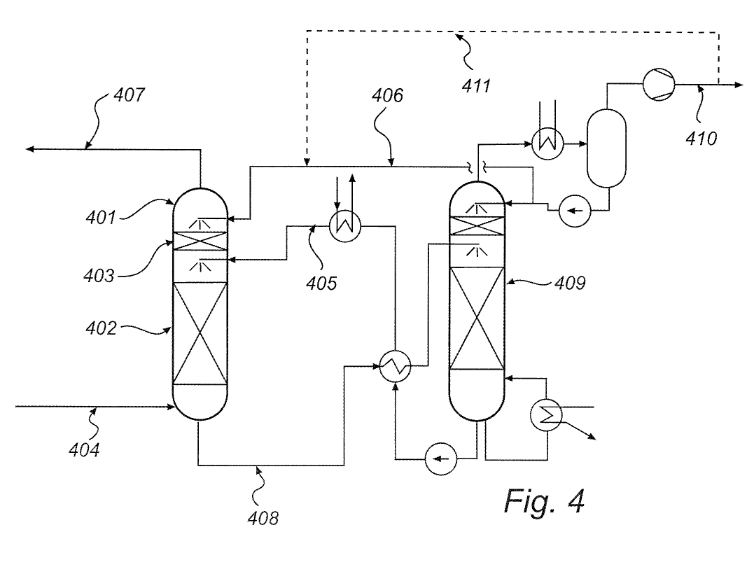

FIG. 4 is a schematic representation of an embodiment of an amine based gas purification system according to the proposed invention. The system comprises an absorption unit (401) arranged to allow contact between a gas stream to be purified and one or more wash liquids. The absorption unit represented in FIG. 4 comprises a CO₂ absorption section (402) and a water wash section (403). Flue gas from which CO₂ is to be removed, is fed to the absorption unit (401) via line (404). In the CO₂ absorption section (402), the flue gas is contacted with a first wash liquid comprising an amine compound, e.g. by bubbling the flue gas through said first wash liquid or by spraying the first wash liquid into the flue gas. The first wash liquid is fed to the absorption unit via line (405). In the CO₂ absorption section (402) CO₂ from the flue gas is absorbed in the first wash liquid. Flue gas depleted of CO₂ in the CO₂ absorption section then enters the water wash section (403) of the absorption unit. The water wash section (403) is arranged to allow contact between the flue gas depleted of CO₂ from the CO₂ absorption section (402) and a second wash liquid, which is generally water. The second wash liquid is fed to the absorption unit via line (406). In the water wash section, contaminants remaining in the flue gas when it leaves the CO₂ absorption section are absorbed in the second wash liquid. Flue gas depleted of CO₂ and contaminants leaves the absorption unit via line (407). The used first and second wash liquid containing absorbed CO₂ and contaminants leave the absorption unit via line (408). The used first and second wash liquid may be recycled via a regenerator unit (409), wherein contaminants are separated from the wash water.

CO₂ removed from the flue gas in the absorption unit is separated from the wash liquid in the regenerator unit (409) for regeneration of the wash liquid. The separated CO₂ leaves the system via line (410). A portion of the CO₂ separated in the regenerator unit is introduced into the wash water to be fed to the water wash unit.

In addition to the mentioned features, the system represented by FIG. 4 further comprises means (411) for introducing CO₂ into said wash water stream upstream of said water wash unit.

### EXAMPLES

### Example 1

### Removal of NH₃ with Water (Comparative Example)

In a commercial plant with a flow scheme as shown in FIG. 1, a gas stream of 1.8×10⁶ Nm³/h of CO₂ depleted and cooled flue gas (5° C., slightly above atmospheric pressure, 93% N₂ and Ar, 1.8% CO₂, 4% O₂) from a coal fired power plant is sent from the main ammonia based CO₂ absorption unit to a water wash column.

Resulting from the contact with aqueous ammonia solution in the ammonia based CO₂ absorption unit, the gas contains about 6000 to 7000 ppmV (parts per million based on volume) of NH₃. In the water wash column the NH₃ content in the gas stream needs to be reduced to a level of 200 ppmV or less, before the flue gas can be routed further.

In the water wash column, the NH₃ is removed by absorption with 600 m³/h of water, obtained from a stripping unit and fed to the top of the water wash column, where it is contacted in countercurrent flow with rising flue gas fed at the bottom of the water wash column. Before being fed to the column, the water is cooled to 5° C. by means of a chilling system.

The amount of wash water required to reach the target of 200 ppmV NH₃ in the flue gas stream was 600 m³/h.

The spent wash water is withdrawn at the bottom of the wash water column with an NH₃ content of 1 to 1.5 wt % and recycled to the stripping unit. In the stripping unit the ammonia is separated from the wash water by stripping with steam generated in the reboiler of the stripping unit. The reboiler is heated by means of 120 tons/h of steam obtained from the power plant steam cycle. The water leaving the stripping unit is depleted in NH₃ to a low residual content, such as about 0.05 wt %, and virtually free from CO₂.

The water leaving the stripping unit is recycled for use in the water wash column.

### Example 2

### Removal of NH₃ with CO₂ Enriched Wash Water

Example 2 was performed as Example 1, with the difference that 1 to 1.5 tons/h of CO₂ were derived from the pressurized liquid product CO₂ (600 tons/hour) after the CO₂ compressor (as shown in FIG. 3), and injected into the cold wash water line between the wash water cooler and the water wash column.

The injection of CO₂ improved the absorption efficiency of the wash water such that the amount of wash water required to reduce the ammonia content of the flue gas stream to the desired 200 ppmV was reduced from 600 (as required in Example 1, without CO₂ injection) to 480 m³/h. Thus only 480 m³/h of spent wash water was sent to the stripper. The amount of steam fed to the stripper reboiler could be reduced proportionally, i.e. by 20% to 96 tons/hour. Hence, the invention yields an energy saving corresponding to 24 tons of steam per hour.

### Example 3

### Removal of Amine Compounds with Water (Comparative Example)

In a commercial plant with a flow scheme as shown in FIG. 2, 2.1 million Nm³/h of flue gas from a coal fired power plant (slightly above atmospheric pressure, 72% N₂ and Ar, 14% CO₂, 3-4% O₂) are sent to an amine absorption unit which is equipped with a CO₂ absorption section as the main section and an integrated water wash section as the top section.

In the CO₂ absorption section, 90% of the CO₂ is absorbed by means of a solution which comprises a mixture of water and an amine compound or a mixture of amine compounds.

Resulting from the contact with the aqueous amine solution in the CO₂ absorption unit, the flue gas from the CO₂ absorption section reaching the water wash section contains about 80 ppmV of the amine. As an undesired side reaction with oxygen present in the flue gas, a small portion of the amine will degrade to form small quantities of volatile degradation products, such as ammonia and acetone, which may also be present in small concentrations in the gas coming from the main CO₂ absorption section. As an example, in the European Castor pilot an ammonia concentration of up to 100 ppmV was measured in the treated gas downstream of the amine absorption unit.

The purpose of the water wash section is to reduce the content of the amine compound(s) down to a residual level of not more than 2 ppmV and the degradation products to environmentally acceptable levels (e.g. <10 ppmV for ammonia). The purpose of the water wash is also to recover the amine compound(s) for recycling purposes.

The amount of wash water required to reach the target content of amine compounds and degradation products was 320 m³/h.

The amine and other trace contaminants are removed by means of absorption with wash water, obtained from the overhead condensing system of the regenerator, which is cooled and pumped to the top of the water wash section. The wash water spent in the water wash section flows down to the main CO₂ absorption section and is joined with the amine compound rich solution and sent to the regenerator, where the amine is recovered.

### Example 4

### Removal of Amine Compounds with CO₂ Enriched Wash Water

Example 4 was performed as Example 3, with the difference that 1 to 2 tons/h of CO₂ derived from the pressurized liquid product CO₂ (600 tons/hour) after the CO₂ compressor (as shown in FIG. 4), and injected into the wash water line between the regenerator overhead system and the water wash column.

The injection of CO₂ improved the absorption efficiency of the wash water such that the amount of wash water required to reduce the residual amine content to the desired 2 ppmV and the ammonia content to less than 10 ppmV was reduced from 320 (as required in Example 3, without CO₂ injection) to 260 m³/h.

1. A method for the removal of contaminants from a gas stream, comprising the steps of:
a) introducing CO₂ into a wash water stream to obtain a CO₂ enriched wash water; and
b) contacting said CO₂ enriched wash water with the gas stream containing contaminants to be removed to allow absorption of the contaminants into the CO₂ enriched wash water.

2. A method according to claim 1, wherein at least one of the contaminants is an alkaline compound.

3. A method according to claim 2, wherein at least one of the contaminants is selected from the group consisting of ammonia and amine compounds, preferably ammonia.

4. A method according to claim 1, wherein the CO₂ enriched wash water comprises 0.01-5 wt % of CO₂, preferably 0.01-2 wt % of CO₂, preferably 0.01-1 wt % of CO₂.

5. A method according to claim 1, wherein the CO₂ introduced into the wash water stream in step a) is in liquid form.

6. A method according to claim 1, wherein step b) is performed in a countercurrent flow mode.

7. A method according to claim 1, wherein step b) is performed in a packed bed column.

8. A method according to claim 1, wherein the CO₂ introduced into the wash water stream in step a) is obtained from a process for removal of CO₂ from a gas stream.

9. A method according to claim 8, wherein said process for removal of CO₂ from a gas stream comprises the step of scrubbing said gas stream with a liquid comprising ammonia or an amine compound, preferably ammonia.

10. A method according to claim 1, wherein in step b) the gas stream containing contaminants to be removed is a product resulting from a process for removal of CO₂, and the CO₂ introduced into the wash water stream in step a) is obtained from said process for removal of CO₂.

11. A method for the removal of contaminants from a gas stream, comprising the steps of:
a) removing CO₂ from a CO₂ rich gas stream to obtain a CO₂ lean gas stream;
b) introducing CO₂ removed from said CO₂ rich gas stream in step a) into a wash water stream to obtain a CO₂ enriched wash water; and
c) contacting said CO₂ enriched wash water with the CO₂ lean gas stream obtained in step a) to allow absorption of contaminants in the CO₂ lean gas stream into the CO₂ enriched wash water.

12. (canceled)

13. A gas purification system comprising a first contactor device arranged for receiving a gas stream and contacting it with a wash water stream, characterized in that said system comprises means for introducing CO₂ into said wash water stream upstream of said contactor device.

14. A gas purification system according to claim 13, wherein said means for introducing CO₂ is adapted for introducing the CO₂ in liquid form.

15. A gas purification system according to claim 13, further comprising a second contactor device arranged for receiving a CO₂ rich gas stream and contacting it with a liquid comprising ammonia or an amine compound to produce a CO₂ lean gas stream, wherein said first contactor device is arranged for receiving said CO₂ lean gas stream and contacting it with a wash water stream, characterized in that said system comprises means for introducing CO₂ into said wash water stream upstream of said first contactor device.

16. (canceled)

17. (canceled)

18. (canceled)

19. (canceled)

20. (canceled)

21. A method according to claim 1, wherein at least one of the contaminants is an alkaline compound.

22. A method according to claim 2, wherein at least one of the contaminants is selected from the group consisting of ammonia and amine compounds, preferably ammonia.

23. A method according to claim 1, wherein the CO₂ enriched wash water comprises 0.01-5 wt % of CO₂, preferably 0.01-2 wt % of CO₂, preferably 0.01-1 wt % of CO₂.

24. A method according to claim 1, wherein the CO₂ introduced into the wash water stream in step a) is in liquid form.

25. A method according to claim 1, wherein step b) is performed in a countercurrent flow mode.

26. A method according to claim 1, wherein step b) is performed in a packed bed column.
